(19) United States
(12) Patent Application Publication
(10) Pub. No.: US 2018/0254909 A1
(43) Pub. Date: Sep. 6, 2018

(54) Virtual Identity Credential Issuance and Verification Using Physical and Virtual Means

(71) Applicant: Lamark Solutions, Inc., Fair Oaks Ranch, TX (US)

(72) Inventor: William A. Hancock, Fair Oaks Ranch, TX (US)

(21) Appl. No.: 15/913,811

(22) Filed: Mar. 6, 2018

Related U.S. Application Data
(60) Provisional application No. 62/467,601, filed on Mar. 6, 2017.
(60) Provisional application No. 62/500,323, filed on May 2, 2017.

(51) Int. Cl. H04L 9/32; H04L 9/00

(52) U.S. Cl. CPC H04L 9/3268; H04L 9/3213; H04L 9/3228; H04L 9/006

(57) ABSTRACT

Systems, methods, and non-transitory machine readable medium for authenticating an identity of a user and facilitating a transaction between the user and a relying party include establishing a communication path with a first electronic device of the user, receiving, an identity credential data points of the user from an identity credential issuer, receiving an identity credential issued by the identity credential issuer from the user, authenticating the identity credential received from the user with the identity credential data points of the user from the identity credential issuer, storing the authenticated identity credential of the user as a virtual identity credential in the memory, establishing a communication path with a second electronic device of the relying party, and facilitating transmission of identity credential information or identity credential verification commands between the user and the relying party.

### CROSS-REFERENCE TO RELATED APPLICATIONS

This application claims the benefit of U.S. Provisional Application No. 62/467,601, filed Mar. 6, 2017 and U.S. Provisional Application No. 62/500,323 filed May 2, 2017, each of which is incorporated by reference herein.

### TECHNICAL FIELD

This specification relates to the field of identity credential issuance and verification and more particularly to systems and methods of virtual identify credential issuance and verification using physical and virtual means.

### BACKGROUND OF THE DISCLOSURE

Presently, technologies exist to authenticate the validity of electronic identity credentials. For example, the Fast Identity Online (FIDO) Alliance promulgates a set of standards for strong multi-factor authentication to web sites and other remote systems, services, or applications. By way of example, FIDO standards help websites ensure that the user presenting credentials for verification to a Relying Party is the same user that registered the account with the Relying Party at an earlier point in time.

Examples of FIDO relevant standards include FIDO Alliance Universal Authentication Framework (UAF) v1.1, FIDO Alliance Proposed Standard, 2 Feb. 2017, as well as FIDO Alliance Universal 2^{nd} Factor (U2F) v1.2, FIDO Alliance Proposed Standard, 11 Apr. 2017, which are herein incorporated by reference.

An additional standard setting organization that promulgates standards for multi-factor authentication to web sites and other remote systems, services or applications is the World Wide Web Consortium (W3C). Amongst others, a relevant W3C standard for this specification includes “Web Authentication: An API for accessing Public Key Credentials—Level 1”, W3C Working Draft, 5 Dec. 2017, which is herein incorporated by reference. This W3C standard defines an Application Programming Interface (API) enabling the creation and use of strong, attested, scoped, public key-based credentials by web applications, for the purpose of strongly authenticating users.

By way of example, the referenced W3C Web authentication standard includes guidance on the execution of certain types of commands, including a “AuthenticatorMakeCredential” command and “AuthenticatorGetAssertion” command.

However, standards like the FIDO and W3C standards intentionally do not address the issue of who the first user claims to be when initially registering the account with the Relying Party. A first user could initially present fraudulent information on initial registration with the Relying Party, and that registration would be accepted in any subsequent transaction with the Relying Party.

Approaches to electronic identity authentication, like those within the FIDO and W3C standards, work well for many web-based services such as social media. However, many individuals, entities or vendors operate on the Internet, or otherwise engage in electronic transactions where the identity of the user needs to be more firmly assured. For example, a medical provider has legal, moral, and ethical obligations to ensure they only release medical records to authorized individuals. When using websites to provide electronic medical records, individual medical providers typically use proprietary identity proofing processes to establish and bind the website identity credential (username and password for example) to an actual patient account. Yet such approaches are susceptible to identity theft if the initial registrant has personally-identifiable information for the patient and is successful in initially registering an account.

Separately, industry and government have developed standards for achieving specified levels of confidence or levels of assurance in identity vetting and authentication. For example, the National Institute of Standards and Technology (NIST) created a series of Special Publications, including a series of publications related to Computer Security, that describe enrollment and identity proofing processes. Examples of such standards include NIST Special Publication 800-63-3, 800-63A, 800-63B, which are herein incorporated by reference.

By way of example, NIST SP 800-63A makes it clear that the objective of identity proofing is to:
a. Resolve a claimed identity to a single, unique user within the context of the population of users a Credential Service Provider serves;
   i. A Credential Service Provider (CSP) is a trusted entity that issues or registers subscriber authenticators and issues electronic credentials to subscribers. The CSP may encompass verifiers that it operates. A CSP maybe an independent third party, or may issue credentials for its own use.
b. Validate that supplied evidence is correct and genuine (e.g., not counterfeit or misappropriated);
c. Validate that the claimed identity exists in the real world; and
d. Verify that the claimed identity is associated with the user supplying the identity evidence.

NIST SP 800-63A categorizes identity credential assurance into three identity levels, called Identity Assurance Levels (IALs). These IALs are defined as:
a. IAL1: “There is no requirement to link the applicant to a specific real-life identity. Any attributes provided in conjunction with the authentication process are self-asserted or should be treated as self-asserted.” This is a weak assurance level.
b. IAL2: “Evidence supports the real-world existence of the claimed identity and verifies that the user is appropriately associated with this real-world identity. IAL2 introduces the need for either remote or physically-present identity proofing. Attributes could be asserted by” CSPs to Relying Parties “in support of pseudonymous identity with verified attributes.” “IAL2 allows for remote or in-person identity proofing. IAL2 supports a wide range of acceptable identity proofing techniques in order to increase user adoption, decrease false negatives (legitimate applicants that cannot successfully complete identity proofing), and detect to the best extent possible the presentation of fraudulent identities by a malicious applicant” or user.
c. IAL3: “Physical presence is required for identity proofing. Identifying attributes must be verified by an authorized and trained representative of the” CSP. “As with IAL2, attributes could be asserted by” CSPs to Relying Parties “in support of pseudonymous identity with verified attributes.” “IAL3 adds additional rigor to the steps required at IAL2, to include providing further evidence of superior strength, and is subjected to additional and specific processes, including the use of biometrics, to further protect the identity and” Relying Party from impersonation, fraud, or other significantly harmful damages.” In addition, identity proofing at IAL3 is performed in-person.

Standards like the NIST standards incorporated by reference herein can provide high confidence in identity assurance, but achieving IAL2 or IAL3 credentials often involves an investment in time and resources that are typically replicated every time a first user seeks to present their identity credential to a Relying Party. In many cases, a user may submit their credential to multiple, different Relying Parties on a daily basis. IAL 2 or IAL 3 reliability for each of those transactions is not economical or practicable.

Accordingly, it would be advantageous to have systems and methods for creating a portable, virtual identity credential with an IAL1, IAL2 or IAL3 level of assurance, with the cryptographic assurance of authentication standards such as used by the FIDO Alliance or the W3C.

### SUMMARY

Consistent with some embodiments, a method, performed by a backend system, of authenticating an identity of a user and facilitating a transaction between the user and a relying party includes establishing a communication path with a first electronic device of the user, receiving, by the backend system, an identity credential data points of the user from an identity credential issuer, receiving, by the backend system, an identity credential issued by the identity credential issuer from the user, authenticating, by the backend system, the identity credential received from the user with the identity credential data points of the user from the identity credential issuer, storing, by the backend system, the authenticated identity credential of the user as a virtual identity credential in the memory, establishing, by the backend system, a communication path with a second electronic device of the relying party, and facilitating transmission of identity credential information or identity credential verification commands between the user and the relying party.

Consistent with some embodiments, a system includes a memory and a processor coupled to the memory. The processor is configured to establish a communication path with a first electronic device of a user, receive an identity credential data points of the user from an identity credential issuer, receive an identity credential issued by the identity credential issuer from the user, authenticate the identity credential received from the user with the identity credential data points of the user from the identity credential issuer, store the authenticated identity credential of the user as a virtual identity credential in the memory, establish a communication path with a second electronic device of the relying party, and facilitate transmission of identity credential information or identity credential verification commands between the user and the relying party.

Consistent with some embodiments, a non-transitory machine-readable medium including a plurality of machine-readable instructions which when executed by one or more processors associated with a backend system are adapted to cause the one or more processors to perform a method. The method includes establishing a communication path with a first electronic device of the user, receiving an identity credential data points of the user from an identity credential issuer, receiving an identity credential issued by the identity credential issuer from the user, authenticating the identity credential received from the user with the identity credential data points of the user from the identity credential issuer, storing the authenticated identity credential of the user as a virtual identity credential in the memory, establishing a communication path with a second electronic device of the relying party, and facilitating transmission of identity credential information or identity credential verification commands between the user and the relying party.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a simplified diagram of a credential issuance and verification system according to some embodiments.

FIG. 2 is a simplified diagram of a system for a binding of a public key infrastructure-based credential to a virtual identity credential according to some embodiments.

FIG. 3 is a simplified diagram of a system for the binding of a physical government-issued ID credential to a virtual identity credential according to some embodiments.

FIG. 4 is a simplified diagram of an exemplary topology to establish a secure, closed, virtual loop according to some embodiments.

FIG. 5 is a simplified diagram of a system for virtual identity credential issuance over a secure, closed, virtual loop according to some embodiments.

FIG. 6 is a simplified diagram of a method of virtual identity credential verification according to some embodiments.

FIG. 7 is a simplified diagram of a method of virtual identity credential verification without a trusted intermediary according to some embodiments.

FIG. 8 is a diagram of a system for virtual identity credential authentication of multiple users by a relying party via a trusted relay according to some embodiments.

### DETAILED DESCRIPTION

This description and the accompanying drawings that illustrate inventive aspects, embodiments, implementations, or modules should not be taken as limiting-the claims define the protected invention. Various mechanical, compositional, structural, electrical, and operational changes may be made without departing from the spirit and scope of this description and the claims. In some instances, well-known circuits, structures, or techniques have not been shown or described in detail in order not to obscure the invention. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Persons skilled in the art will recognize that many modifications and variations are possible in the details, materials, and arrangements of the components and actions which have been described and illustrated in order to explain the nature of this inventive concept and that such modifications and variations do not depart from the spirit and scope of the teachings and claims contained therein.

According to some embodiments, pairing an independently verified physical identity credential with a virtual identity credential, and then allowing a Relying Party to verify the virtual identity credential, will now be described with more particular reference to the attached drawings. Hereafter, details are set forth by way of example to facilitate discussion of the disclosed subject matter. It should be apparent to a person of ordinary skill in the art, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, 1002-1 may refer to a “pen,” which may be an instance or example of the class of “writing implements.” Writing implements may be referred to collectively as “writing implements 1002” and any one may be referred to generically as a “writing implement 1002.”

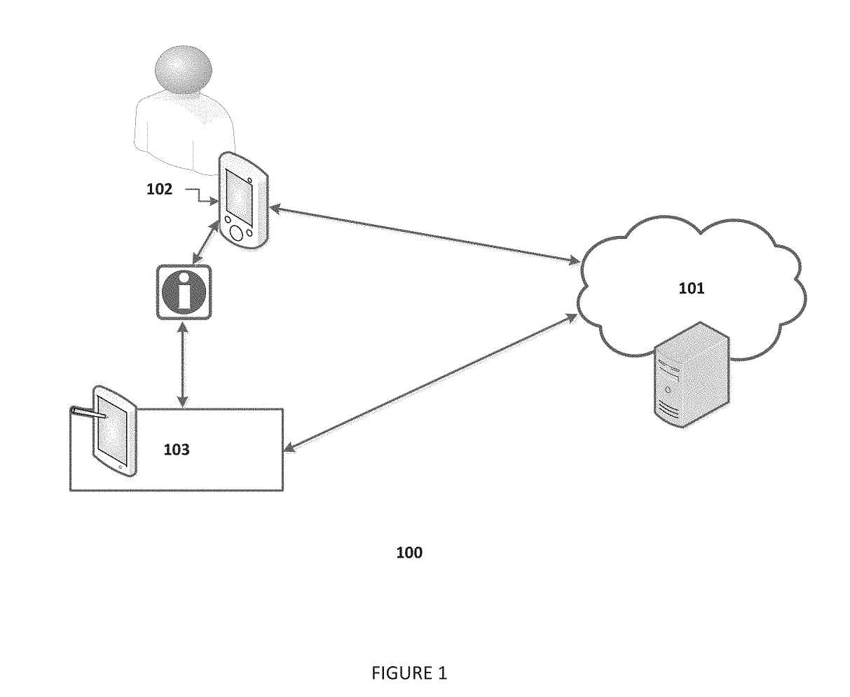

FIG. 1 is a simplified diagram of a credential issuance and verification system 100 according to some embodiments. As shown in FIG. 1, system 100 includes (1) a backend system 101 residing in either a distributed electronic storage medium (e.g., computer cloud storage), localized electronic storage medium (e.g., local computer server farm) and/or the like, (2) a front-end software application either residing on or temporarily-stored on a user's electronic device 102 (e.g., smartphone, tablet, computer, wearable electronic device, or Internet of Things (IoT) electronic device, and/or the like), and (3) a backend service through a software application either residing on or temporarily-stored on a relying party's electronic device 103.

In some examples, each of backend system 101, user's electronic device 102, and/or relying party's electronic device 103 may include one or more processors. Each of the one or more processors may be consistent with a central processing unit, a multi-core processor, a microprocessor, a microcontroller, a digital signal processor, a field programmable gate array (FPGA), an application specific integrated circuit (ASIC), a graphics processing unit (GPU) and/or the like. In some examples, each of backend system 101, user's electronic device 102, and/or relying party's electronic device 103 may be implemented as a stand-alone subsystem and/or as a board added to a computing device or as a virtual machine.

In some examples, each of backend system 101, user's electronic device 102, and/or relying party's electronic device 103 may include memory that may be used to store software executed by the one or more processors and/or one or more data structures used during operation of backend system 101, user's electronic device 102, and/or relying party's electronic device 103. The memory may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

In some examples, one or more of backend system 101, user's electronic device 102, and/or relying party's electronic device 103 may be interconnected by one or more networks. In some examples, the one or more networks may include one or more local area networks, (e.g., an Ethernet), one or more wide area networks (e.g., the Internet), one or more wireless networks, one or more cellular networks, and/or the like.

Some examples of verification system 100 may be consistent with a Lamark Solutions Credential Issuance and Verification Ecosystem provided by Lamark Solutions, Inc. of Fair Oaks Ranch, Tex.

According to some embodiments, a first user may initially bind an existing physical world identity credential to a unique account stored in the backend system through the use of the front-end software application installed on the user's electronic device. Several possible methods exist for binding the credential. In some embodiments, the binding method may be selected based on the type of physical-world credential and/or the Information Assurance Level (IAL) the first user desires the virtual identity credential to possess.

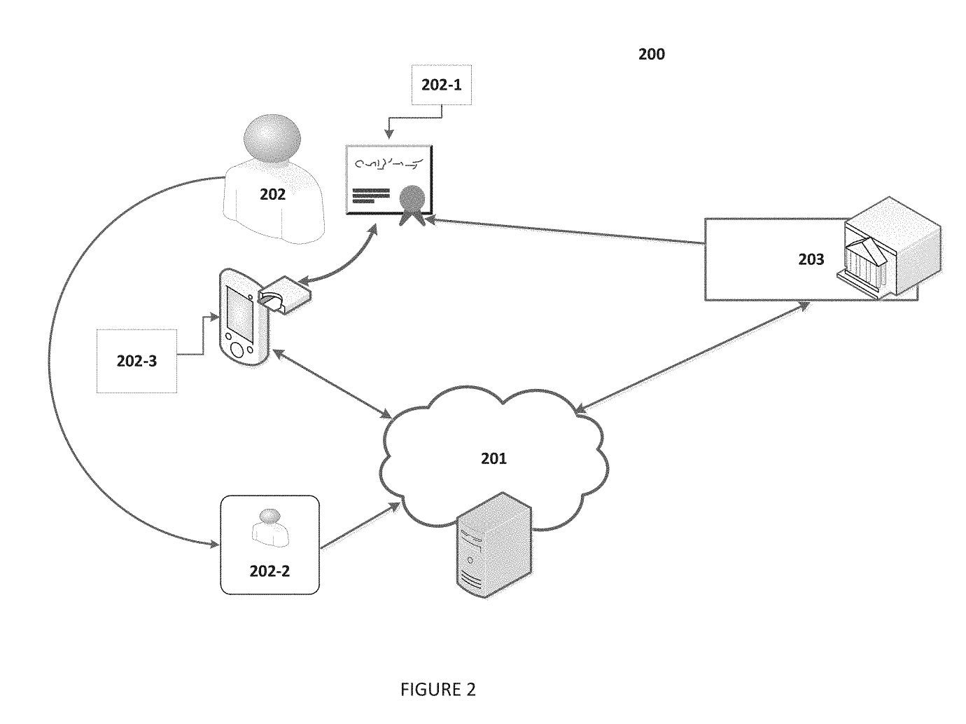

FIG. 2 is a simplified diagram of a system 200 for binding of a public key infrastructure (PKI)-based credential to a virtual identity credential according to some embodiments. As shown in FIG. 2, a system 200 for cryptographic binding to an existing real-world PKI-based identity credential 202-1, such as Department of Defense (DOD) Common Access Cards (CACs) and Federal Information Processing Standard (FIPS) 202-1 Personal Identity Verification (PIV) credentials, is depicted. In some examples, PKI-based identify credential 202-1 may include a smart card, RFID chip, and/or the like. In some examples, these credentials already express a NIST identity assurance level, and once verified, that assurance level may flow through into a user's derived virtual identity credential. According to some embodiments, the binding of an existing PKI credential 202-1 may be accomplished by the following process: (1) the PKI-based identity credential issuing authority 203 is registered with the backend system 201 through a separate process, for example a manual registration process, or via client-authenticated SSL/TLS and/or the like, thereby allowing the backend system 201 to understand how to recognize and parse the PKI-based identity credential 202-1; (2) the PKI-based identity credential 202-1 proffered by the user 202 passes standard PKI credential verification and validation steps (e.g., is trusted, is time valid, is not revoked, and/or the like); (3) the identity expressed in the proffered PKI-based identity credential 202-1 credential may match a pre-registered profile 202-2 input by the user in the backend system 201 and/or the identity credential expressed in the proffered PKI-based identity credential 202-1 may simply be translated to the backend system 201 without the need for the use of a pre-registered profile 202-2; and (4) using a front-end software application contained on the user's electronic device 202-3, the user demonstrates possession of a private key by performing a digital signature operation at the request of the backend system 201. In some examples, user's electronic device 202-3 may be consistent with user's electronic device 102 and/or backend system 201 may be consistent with backend system 101. In some examples, PKI-based identity credential issuing authority 203 may be the U.S. Department of Defense (DoD), the U.S. Department of Homeland Security, and/or the like. In some examples, the communication path between backend system 201 and PKI-based identity credential issuing authority 203 may be a secure communication path, such as a network connection using secure socket layering (SSL), transport layer security (TLS), and/or the like. In some examples, the cryptographic binding process may occur via a front-end software application that could be a web-based interface on the user's electronic device 202-3 that has an apparatus or device (e.g., a CAC reader) designed to read the physical media on which the PKI-based identity credential 202-1 resides on (e.g., a CAC) and/or the like. In some examples, the backend system 201 may archive the proof of possession (digital signature) along with a copy of the public certificate as evidence of the binding.

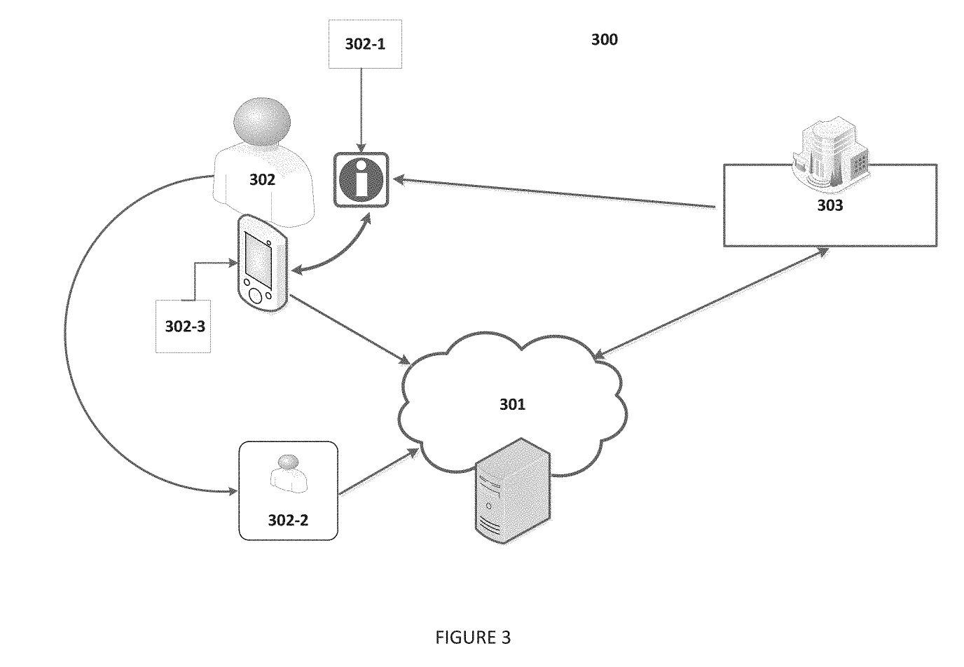

FIG. 3 is a simplified diagram of a system 300 for binding of a physical government-issued ID credential to a virtual identity credential according to some embodiments. As shown in FIG. 3, system 300 for digitized binding to an existing physical-world credential for government-issued ID (e.g., passports, driver licenses, identity cards, known traveler identity cards, and/or the like) is depicted. According to some embodiments, the binding of an existing government-issued ID credential 302-1 may be accomplished by the following process: (1) the government authority 303 from which the government-issued ID credential 302-1 has been issued is registered with the backend system 301, thereby allowing the backend system 301 to understand how to recognize and parse the government-issued ID credential 302-1 based on a comparison of unique individual data points (e.g., hair color, eye color, height, weight, name, Social Security Number, date of birth, and/or the like) specified by the government authority 304; (2) the government-issued ID credential 302-1 proffered by the user 302 is successfully digitized and analyzed through the front end software application leveraging a sensor (e.g., a camera, scanner, bar code reader, and/or the like) on a user's electronic device 302-3 to capture an image or scan of the government-issued ID credential 302-1; (3) the image or scan is then transmitted by the front end software application on the user's electronic device 302-3 to the backend system 301, which analyzes and compares the image or scan sent by the user's electronic device 302-3 to data points provided by the government authority 304 via the registration process described in step (1); and (4) the identity expressed in the extracted data from the proffered government-issued ID credential 302-1 matches the user's registered profile 302-2 contained in the backend system 301 and/or the identity credential expressed in the proffered government-issued ID credential 302-1 may simply be translated to the backend system 301 without the need for the use of a pre-registered profile 202-2. In some examples, government authority 303 may be the U.S. Department of State, a state Department of Motor Vehicles, and/or the like, and in some examples, government authority 303 may be consistent with, or even the same as, the PKI-based identity credential issuing authority 203. In some examples, the communication path between backend system 301 and the government authority 303 may be a secure communication path, such as a network connection using sSSL, TLS, and/or the like. In some examples, the backend system 301 may be consistent with backend system 101 and/or 201 and/or user's electronic device 302-3 may be consistent with user's electronic device 102 and/or 202-3.

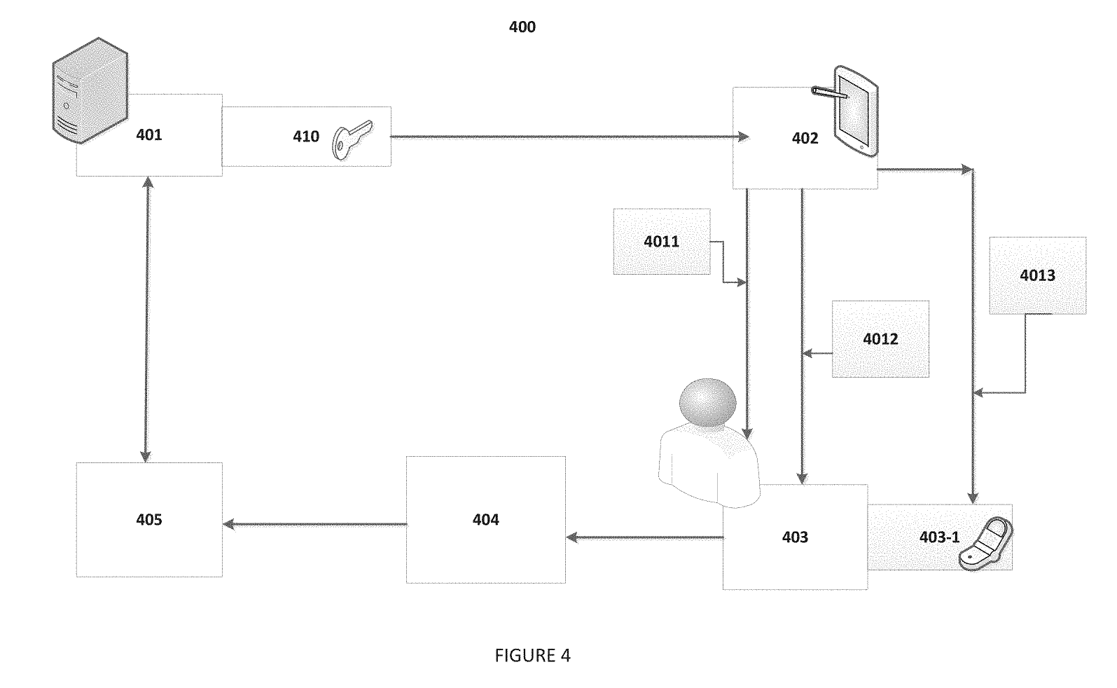

FIG. 4 is a simplified diagram of an exemplary approach 400 to establish a secure, closed, virtual loop according to some embodiments. FIG. 4 depicts approach 400 for establishing a secure, closed, virtual loop for communication through which a unique correlation token 410 may travel from a starting point, traversing one or more communication nodes, eventually returning to the point of origin, having passed through a number of topologically diverse points along the way.

The origin node 401 may communicate the unique correlation token 410 to a known first communication node 402 through a proprietary protocol secured by secure communication path, such as a network connection using SSL, TLS, and/or the like. The first communication node 402 may further present the unique correlation token 410 to a second communication node 403 known to the first communication node 402, but not known to the origin node 401. The communication between the first communication node 402 and the second communication node 403 is secured through one or more methodologies appropriate for the translation of the unique correlation token across diverse mediums and topologies. For example, the communication between nodes may be secured according to one or more approaches.

According to some embodiments, one possible approach is using physical control 4011. In some examples, the translation of the unique correlation token 410 between communication nodes is secured by physical control of one node over the other node. An example of use of physical control to secure said translation would be an electronic device (e.g., a tablet computer, smart phone, laptop computer, and/or the like) as the first communication node 402 physically controlled by a user as the second communication node 403.

According to some embodiments, one possible approach is using visual proximity 4012. In some examples, the translation of the unique correlation token 410 between communication nodes is secured by visual proximity of the communicating nodes. An example of use of visual proximity would be an electronic device (e.g., a tablet computer, smart phone, laptop computer, and/or the like) as the first communication node 402 displaying the unique correlation token 410 such that a user as the second communication node 403 can visually perceive the unique correlation token 410.

According to some embodiments, one possible approach is using radio proximity 4013. In some examples, the translation of the unique correlation token 410 between communication nodes is secured by radio communications within a near field. An example of radio proximity is a wearable or electronic device (e.g., a tablet computer, smart watch, wearable such as a Fitbit, smart phone, laptop computer, and/or the like) as the first communication node 402 communicating with a wearable or computing device 403-1 (e.g., a smart watch, wearable such as a Fitbit, smart glasses, smart phone, laptop computer, and/or the like) as the second communication node 403 via Bluetooth, near-field communication (NFC), and/or another similar communications methodology.

According to some embodiments, the transmission security between communication nodes using physical control, visual proximity, radio proximity, and/or the like may be further assured through using additional authentication factors, for example, such as a biometric characteristic, PIN, password, passphrase, and/or the like in order for the unique correlation token 410 to be translated between communication nodes.

According to some embodiments, communication of the unique correlation token between the second communication node 403 through an unknown number (or N number) of intermediate communication nodes 404 and to the last communication node 405 may be secured in the same or different method as the communication between the origin node 401, first communication node 402 and/or second communication node 403.

Translation of the unique correlation token 410 between the last communication node 405 and the origin node 401, with the last communication node 405 being known to origin node 401, may be secured through various means, including physical control, visual proximity, radio proximity, a proprietary protocol secured by an existing open standard, such as SSL, TLS and/or the like, or via FIDO-as-a-Service (FAAS) protocol as described further in this specification. In some examples, communication between the origin node 401 to first communication node 402 may also be secured via FAAS protocol. In some examples, the secure, closed, virtual loop may be used for virtual identity credential issuance or verification.

In some examples, origin node 401 may be consistent with the backend system 101, 201, and/or 301.

According to some embodiments, the communication flow path of unique correlation token 410 within the secure, closed, virtual loop may be reversed from that displayed in FIG. 4.

According to some embodiments, an organization may use the secured, closed, virtual loop displayed in FIG. 4 for binding a physical identity credential. In some examples, universities, large employers, state driver license bureaus, and/or the like may have existing identity vetting processes incorporated into their physical-world identity credential issuance systems. Integrated issuance may involve custom integrations with existing systems and processes to use in the secured, closed, virtual loop.

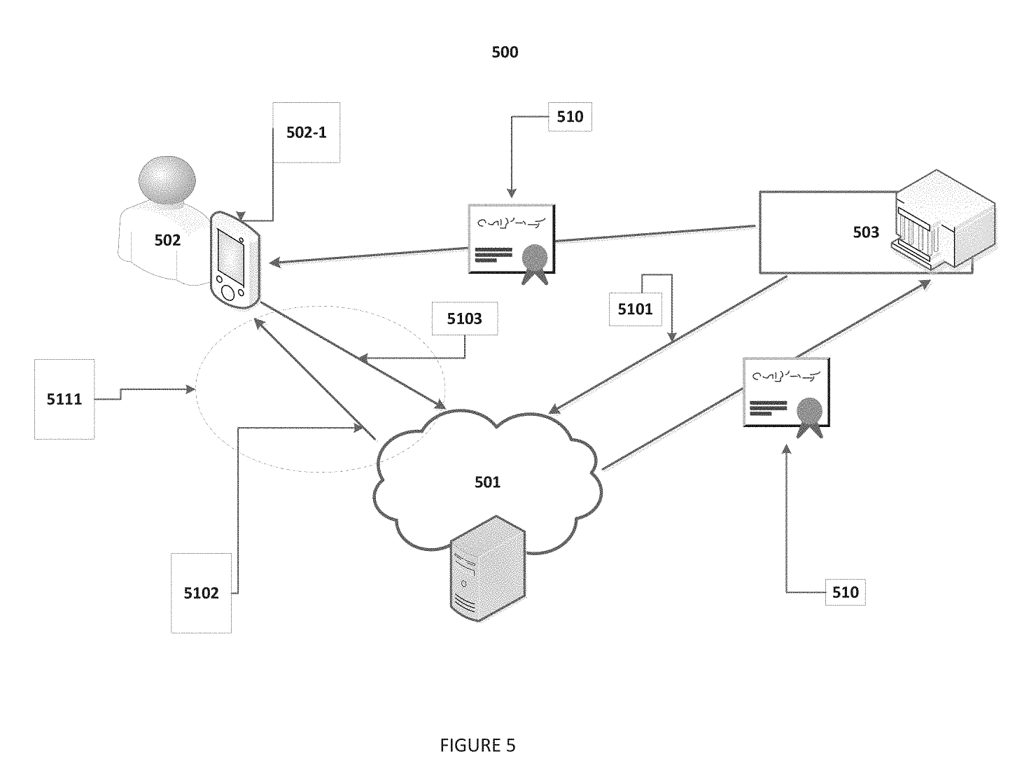

FIG. 5 is a simplified diagram of a system 500 for virtual identity credential issuance over a secure, closed, virtual loop according to some embodiments. As shown in FIG. 5, system 500 may involve a registered organization, such as a university, large employer, state driver license bureaus, and/or the like that acts as an identity credential issuer 503. The identity credential issuer 503 may send user-specific data points 5101 (e.g., name, date of birth, student/employee ID number, height, Social Security Number, and/or the like) to a backend system 501 and may request and receive a one-time unique correlation token 510 that the identity credential issuer 503 presents to a user 502. According to some embodiments, presentation of the one-time unique correlation token 510 from the identity credential issuer 503 to the user 502 may be made in a variety of ways, for example in visual form using a human-readable (e.g., passcode, passphrase, PIN, six-digit alphanumeric code, unique symbol, and/or the like), or machine-readable (e.g., QR code, bar code, and/or the like), or through audible form (e.g., specific sequence of notes or a known musical song, and/or the like), or through near-field radio transmission (e.g., Bluetooth, NFC, and/or the like). According to some embodiments, the user 502 may then scan, record, or otherwise deposit (e.g., by using a camera, scanner, bar-code reader, microphone, and/or the like) the one-time unique correlation token 510 with a front end software application on a user's electronic device 502-1 (e.g., smartphone, tablet, computer, wearable electronic device, or Internet of Things (IoT) electronic device, and/or the like) or user 502 may enter the one-time unique correlation token 510 manually (e.g., by using a keyboard, touchscreen, stylus, and/or the like) into their electronic device 502-1. The front end software application on the electronic device 502-1 communicates with the backend system 501, and in some embodiments establishes a secure communication session 5111 for example via a secure communication path, such as a network connection using SSL, TLS and/or the like, or via FAAS protocol as described further in this specification. According to some embodiments, the electronic device 502-1 receives a FIDO or W3C MakeCredential command and/or the like, and a private key 5102, and supplies a public key 5103 portion of a FIDO or W3C keyset and retrieving virtual identity credential information from the backend system 501. According to some embodiments, following the communication between the electronic device 502-1 and backend system 501, the electronic device 502-1 has the private key 5102 and the user-specific data points 5101, and the backend system 501 has the public key 5103 and the user-specific data points 5101.

According to some embodiments, the backend system 501 may bulk archive vetted user-specific data points 5101 sent from the identity credential issuer 503 in a format that is accessible, which may include storage of the archived identity information in a system that is not directly accessible by the user 502 or another third-party/relying party.

In some examples, identity credential issuer 503 may be a university, an employer, a non-governmental organization, or a disaster relief organization, and/or the like. In some examples, identity credential issuer 503 may be consistent with the PKI-based identity credential issuing authority 203 or government authority 303. In some examples, the communication path between backend system 501 and the identity credential issuer 503 may be a secure communication path, such as a network connection using secure socket layering (SSL), transport layer security (TLS), and/or the like. In some examples, the backend system 501 may be consistent with backend system 101, 201, and/or 301 and/or user's electronic device 502-1 may be consistent with user's electronic device 102, 202-3, and/or 302-3.

Upon completing of a binding process, which may include the three embodiments described above, and may include establishment of the secured, closed, virtual loop, a virtual identity credential (e.g., a virtual ID card) may be employed from a user's electronic device 502-1 to carry out improved systems and methods for secure electronic transactions with the assurance of a FIDO or W3C, and NIST SP800-63 compliant authenticator.

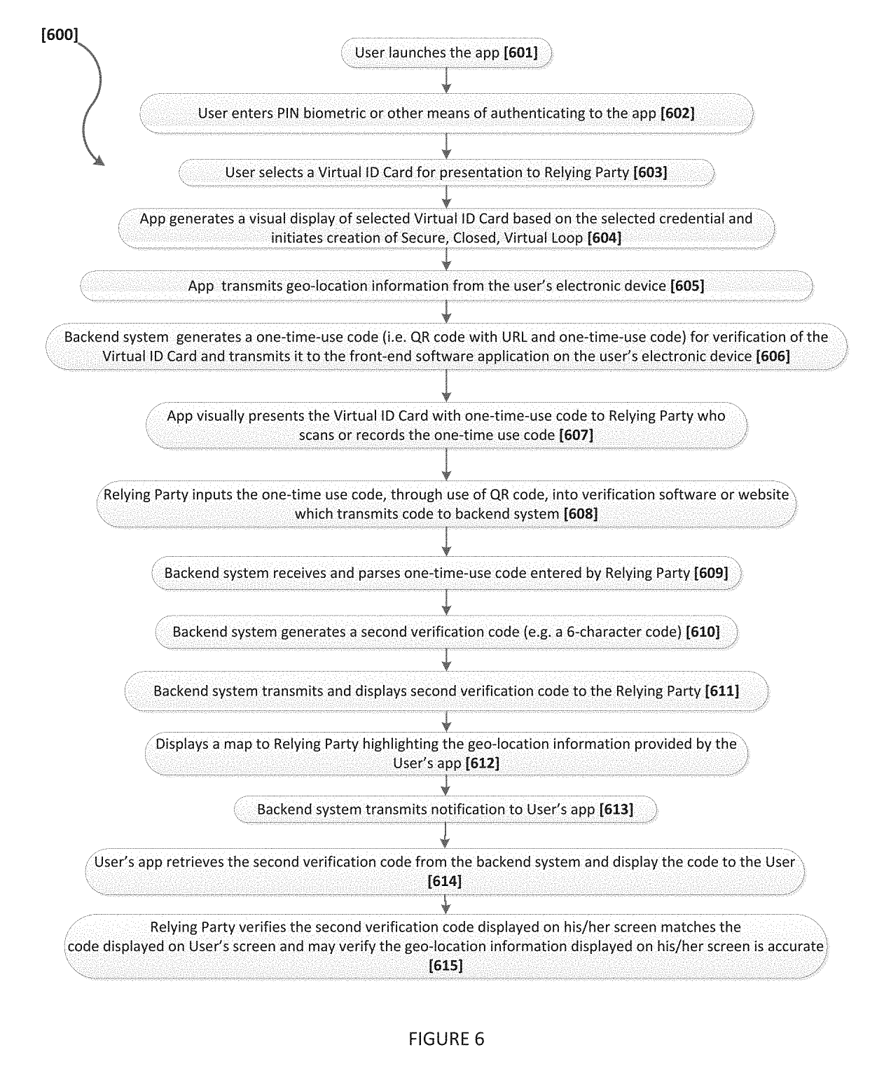

FIG. 6 is a simplified diagram of a method 600 of virtual identity credential verification according to some embodiments. One or more of the processes 601-615 of method 600 may be implemented, at least in part, in the form of executable code stored on non-transitory, tangible, machine-readable media that when run by one or more processors (e.g., one or more processors in backend system 101, user's electronic device 102, and/or relying party's electronic device 103) may cause the one or more processors to perform one or more of the processes 601-615. And although method 600 is described within the context of the devices and systems in FIG. 1, method 600 may also be performed by the devices and systems in any one of FIGS. 2-5.

As shown in FIG. 6 for example:

At a process 601, the user may first launch the front-end software application through a graphical user interface on their electronic device. In some examples, the user may select an icon on a smart phone or a tablet to launch the front-end software application.

At a process 602, the user may thereafter enter a passcode, passphrase, PIN, biometric data, and/or the like for authenticating the user and granting access to the front-end software application in accordance with, for example, FIDO or W3C standards. In some examples, the user may input a six-digit alphanumeric code, press their thumbprint, and/or look into the camera on a smart phone and/or tablet when prompted by the front-end software application to carry out the authentication.

At a process 603, the user may then select the virtual ID card or may select from a list of available multiple virtual ID cards the one that the user desires to provide to the relying party. In some examples, the user may use a virtual ID card stemming from the binding processes disclosed in any one of FIGS. 2-5.

At a process 604, the front-end software application may then create a visual display of the virtual ID card and may initiate the creation of a secure, closed, virtual loop for the purposes of authenticating the virtual ID card with the relying party. In some examples, a visual display on a smart phone or tablet may include a photograph of the user, a logo, user-specific data points, color sequence or animation, and/or the like within the visual display. At a process 605, the front-end software application may transmit through an electronic interface (e.g., wireless connection to the Internet, cellular phone network connection, Ethernet connection, FAAS connection, and/or the like) geo-location information for the user's electronic device to the backend system. In some examples, the geo-location information could be latitude/longitude, a Google map displaying user's location, a Google Streetview image of user's location, and/or the like.

At a process 606, upon initiation of the secure, closed, virtual loop for verification purposes, the backend system generates a one-time use code (e.g., QR code with a URL, one-time-use code, PIN, and/or the like) for verification of the virtual ID card and transmits it to the front-end software application on the user's electronic device. In some examples, the virtual ID card may be visually displayed in machine-readable (e.g., QR code, bar code, and/or the like) and/or human-perceivable format (e.g., alphanumeric display, animation, number sequence, audible tone, and/or the like) on the user's electronic device to carry out this step. The virtual ID card may also be presented to the relying party via other forms, such as a radio signal via Bluetooth, NFC, and/or the like.

At a process 607, the relying party may then scan, record, or analyze the virtual ID card's one-time use code presented by the user. In some examples, the relying party may use a camera, scanner, keyboard, touchscreen, bar code reader, microphone, and/or the like on the relying party's electronic device to perform process 607.

At a process 608, the relying party may input the one-time use code into a software interface that communicates with the backend system. In some examples, the relying party may scan a QR code, receive a Bluetooth-linked message that contains the one-time use code, or the relying party may enter the human-readable code into a software interface for the backend system (e.g., an Internet browser, smart phone app, cloud-based software application, and/or the like), and/or the like to perform process 608.

At a process 609, the backend system may parse the one-time use code and may communicate with both the user's electronic device and the relying party's electronic device. In some examples, the backend system may take one or more of the following actions:

Use a process 610 to generate a second, unique one-time use verification code. In some examples, the second, unique one-time use verification code could be QR code with a URL, a bar code, a one-time-use code, PIN, six-digit alphanumeric code, a unique set of images, a unique set of audible tones or a specific musical song, and/or the like.

Use a process 611 to transmit and display the second one-time use verification code to the relying party.

Use a process 612 to display a geographic map to the relying party highlighting the geo-location information from process 605 that may have been provided by the user's front-end software application. In some examples, this could be GPS coordinates, latitude/longitude, Google Map, a Google StreetView image, and/or the like.

Use a process 613 to transmit a notification to the user's front-end software application on the user's electronic device that the prior actions are complete. In some examples, the notification could be text message to a smart phone or an email message to specified account, and/or the like.

Use a process 614 to allow the user's front-end software application to retrieve the second one-time use verification code from the backend system and display it on the user's electronic device.

Use a process 615 to authorize the relying party to compare the second one-time use verification code presented on the user's electronic device to that transmitted by the backend system to the relying party. In some examples, this may include visual/audible or machine comparison (e.g., using an imaging device) of second one-time use verification code shown in human-perceivable format, such as a comparison of a unique set of images, alphanumeric characters, PIN, audible tones, and/or the like. In some examples, this may include machine comparison of the second one-time use verification when in machine-readable format, such as a QR code, bar code, PIN, and/or the like. In some examples, the relying party may also be authorized to compare the geo-location information of the user to that transmitted by the backend system to the relying party using the same or similar examples as to compare the second one-time use verification code.

According to some embodiments, method 600 allows for several advantages over other approaches. In some examples, method 600 allows the relying party with electronic device 103, equipped to read machine-readable code and Internet, or other electronic network access, to authenticate the virtual ID card presented by the user on the user's electronic device 102. With the human-readable or machine-readable displays, including display of for example, a URL and one-time use code, QR code, bar code, or unique set of image, or a unique set of audible tones, the previously recited process will also allow for a relying party to verify the virtual ID card provided they have Internet (or other network) access to communicate with the backend system 101.

In some examples, the second one-time use verification code of process 610 permits the backend system 101 to act as a trusted intermediary and present the same exact data to both the user and user's electronic device 102 and relying party and relying party's electronic device 103, thereby confirming to the relying party that the user's identity is both verified and trusted to the backend system 101. In some examples, both the one-time use code of process 606 and the second one-time use verification code of process 610 may be in various formats. In some examples, the formats may include one or more of a series of alphanumeric characters, a PIN, a passcode, a passphrase, a shape, a unique sequence of shapes, a color, a unique picture or set of pictures, a unique set of audible tones, musical notes or a song, a series of flashes or vibrations from the user's and relying party's electronic devices, and/or the like.

According to some embodiments, the relying party may also use a copy of the same front-end software application on relying party's electronic device 103 configured in a different mode as possessed by the first user on user's electronic device 102 to conduct method 600.

According to some embodiments, a user's electronic device 102 may act as a first communication node 402 or last communication node 405 and communicate with the origin node 401 to conduct method 600.

As discussed above and further emphasized here, FIG. 6 is merely an example which should not unduly limit the scope of the claims. One of ordinary skill in the art would recognize many variations, alternatives, and modifications. In some embodiments, the order of the processes of method 600 may occur in orders other than those implied by FIG. 6. In some examples, the front-end software application may create a visual display of virtual ID cards before the user enters a PIN and/or selects which virtual ID card to use. Moreover, one or more of the above-described steps may be omitted. In some examples, the user need not transmit any geo-location information to the backend system.

According to some embodiments, method 600 may be adapted to other verification scenarios. In some examples, in a high-throughput scenario where there are many first users whose virtual ID's cards may be verified (e.g., entrance to a sporting event, mass transit station entrance, secured entry to a large office building or factory complex, entrance to a business conference, and/or the like), it may be advantageous for the second one-time use verification code to be displayed as, for example: (1) a colored background over which a specific geometric shape is placed; (2) a single digit inside a geometric shape; and/or (3) a vibration or sound emitting from the relying party's electronic device corresponding to the number or geometric shape displayed on the user's electronic device. In some examples, other displays and/or presentations of the virtual ID card on the electronic device of the relying party may also permit notice to the relying party of what IAL the virtual ID card may possess under NIST or similar standards.

In some examples, it may be advantageous for the relying party, or multiple relying parties, to interface with the backend system through the relying party's electronic devices on a variety of bases, including:
a. On-Demand Pull: where relying party requests attributes for a first user on an ad-hoc basis. In some examples, this could be upon hiring of an employee or registration of a student at a university, and/or the like;
b. Batch Pull: where relying party requests attributes for more than one user on an ad-hoc or scheduled basis. In some examples, this could be at the start of the work week at a corporation, the start of a school semester at a university or primary school, prior to a large sporting event, and/or the like;
c. On-Demand Push: where relying party receive attributes for a first user on an ad-hoc basis, driven by a change in the attribute of that first user. In some examples, this could be based on change in employment status of the user at a company, or registration status of a user at a university, or security clearance status at with an employer or U.S. Department of Defense or Homeland Security, and/or the like;
d. Batch Push: where relying party receives attributes for multiple users on a scheduled basis. In some examples, this could be on a weekly or monthly period to ensure updated attributes, or upon initial registration of the relying party with the backend system, or after a period of prolonged loss of connectivity between the relying party and backend system, and/or the like.

According to some embodiments, the scenarios described have various advantages. For example, Pull scenarios may be useful where relying parties want to build an initial profile for a specific first user for subsequent use. Push scenarios may be useful where relying parties want to ensure their local, cached information for a first user or multiple first users remains up-to-date.

The improved system and method described herein may also provide a mechanism for relying parties to send push notifications to users through the trusted backend system and the user's front-end software application. This enables relying parties to deliver near-real-time alerts and notifications to associated users. For example, university or employer campus safety notifications could be achieved in this manner.

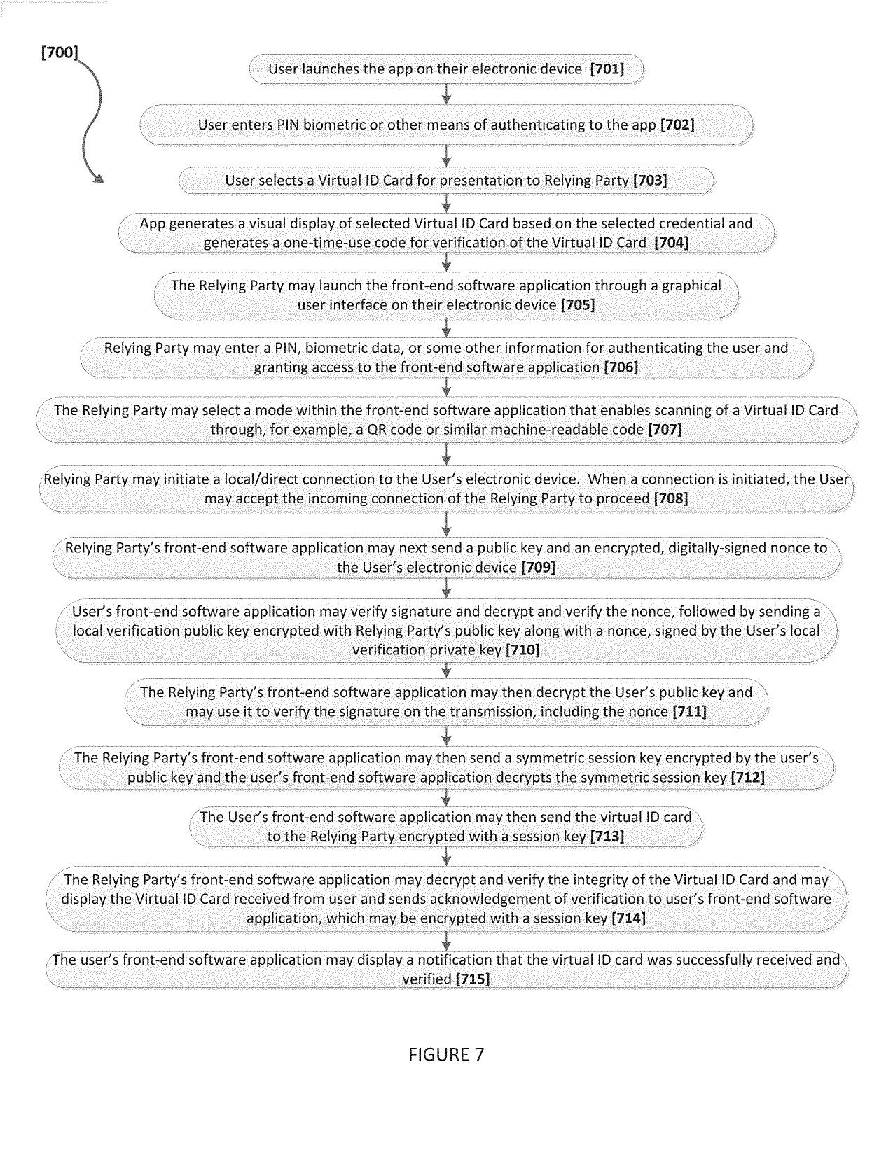

FIG. 7 is a simplified diagram of a method 700 of direct virtual identity credential verification without the use of a trusted intermediary. One or more of the processes 701-715 of method 700 may be implemented, at least in part, in the form of executable code stored on non-transitory, tangible, machine-readable media that when run by one or more processors (e.g., one or more processors in user's electronic device 102, and/or relying party's electronic device 103) may cause the one or more processors to perform one or more of the processes 701-715. And although method 700 is described within the context of the devices and systems in FIG. 1, method 700 may also be performed by the devices and systems in any one of FIGS. 2-5. According to some embodiments, the previously recited binding systems and processes of FIG. 2-6 may be used to link a first user's physical real-world credential to create a virtual ID card and may occur prior to executing the processes 701-715.

At a process 701, the first user may first launch the front-end software application, including for example through a graphical user interface on their electronic device. In some examples, the user may select an icon on a smart phone or a tablet to launch the front-end software application.

At a process 702, in connection with launching the front-end software application, the first user may enter a PIN, biometric data, or some other information for authenticating the first user and granting access to the front-end software application in accordance with, for example, FIDO or W3C standards. In some examples, the user may do one or more of input a six-digit alphanumeric code, press their thumbprint, and/or look into the camera on a smart phone or tablet when prompted by the front-end software application.

At a process 703, the user may then select the virtual ID card, or select from a list of available multiple virtual ID cards the one that the user desires to provide to the relying party. In some examples, the user may use a virtual ID card stemming from the binding processes disclosed in any one of FIGS. 2-5 to carry out this step.

At a process 704, the front-end software application may create a visual display of the virtual ID card and may generate a one-time use code (e.g., QR code with URL and one-time-use code) for verification of the virtual ID card. The virtual ID card may optionally be visually displayed in both machine-readable as well as in human-perceivable format. The virtual ID card may also be presented to the relying rarty in other forms (e.g., radio communication via Bluetooth, NFC, and/or the like). In some examples, a visual display on a smart phone or tablet may include a photograph of the user, a logo, user-specific data points, color sequence or animation, and/or the like to carry out this step. In some examples, the presentation could be a QR code with a URL, a bar code, a one-time-use code, PIN, six-digit alphanumeric code, a unique set of images, a unique set of audible tones or a specific musical song, and/or the like.

At a process 705, the relying party may launch the front-end software application, as for example through a graphical user interface on the relying party's electronic device. In some examples, the relying party may select an icon on a smart phone or a tablet to launch the front-end software application.

At a process 706, in connection with launching the front-end software application, the relying party may enter a PIN, biometric data, or some other information for authenticating the relying party and granting access to the front-end software application in accordance with, for example, FIDO or W3C standards. In some examples, the relying party may input a six-digit alphanumeric code, press their thumbprint, and/or look into the camera on a smart phone or tablet when prompted by the front-end software application.

At a process 707, the relying party may select a mode within the front-end software application that enables scanning or analyzing of a virtual ID card. In some examples, this may include use of sensors linked, attached, or resident on the relying party's electronic device (e.g. camera, microphone, and/or the like) to record the visual display on a user's smart phone and/or tablet, with the display including a photograph of the user, a logo, user-specific data points, color sequence or animation, a QR code with a URL, a bar code, a one-time-use code, PIN, six-digit alphanumeric code, a unique set of images, a unique set of audible tones or a specific musical song, and/or the like.

At a process 708, based on information in contained in the visual display of the virtual ID card presented by the user (e.g., a QR code, bar code, and/or the like), the relying party may initiate local/direct communication path (e.g., a Bluetooth, NFC, AirDrop, local WiFi and/or the like) to the first user's electronic device. When a connection is initiated, the user may accept the incoming connection of the relying party to proceed.

At a process 709, the relying party's front-end software application may next send a public key and an encrypted, digitally-signed nonce to the user's electronic device. In some examples, the nonce may consist of a set of random or pseudo-random numbers or letters to carry out this step.

According to some embodiments, the user's front-end software application may use a local verification keyset, (e.g., asymmetric key pair) for application-to-application verification. In some examples, the local verification keyset may be preset to a limited period of time (e.g., 1 week, 30 days, 45 days, and/or the like) and after the preset period of time, the front-end software application may create a new keyset at the next application-to-application verification session.

At a process 710, upon receiving the public key and nonce from the relying party, the user's front-end software application may verify signature and decrypt and verify the nonce, followed by sending a local verification public key encrypted with relying party's public key along with a nonce, signed by the user's local verification private key. In some examples, the nonce may consist of a set of random and/or pseudo-random numbers, letters, and/or characters.

At a process 711, the relying party's front-end software application may then decrypt the user's public key and may use it to verify the signature on the transmission, including the nonce.

At a process 712, the relying party's front-end software application may then send a symmetric session key encrypted by the user's public key and the user's front-end software application decrypts the symmetric session key.

At a process 713, the user's front-end software application may then send the virtual ID card to the Relying Party encrypted with the session key.

At a process 714, the Relying Party's front-end software application may decrypt and verify the integrity of the virtual ID card and may display the virtual ID card received from user and sends acknowledgement of verification to user's front-end software application, which may be encrypted with the session key.

At a process 715, the user's front-end software application may display a notification that the virtual ID card was successfully received and verified.

As discussed above and further emphasized here, FIG. 7 is merely an example which should not unduly limit the scope of the claims. One of ordinary skill in the art would recognize many variations, alternatives, and modifications. In some embodiments, the order of the processes of method 700 may occur in orders other than those implied by FIG. 7. In some examples, the front-end software application may create a visual display of Virtual ID Cards before the user enters a PIN and/or selects which Virtual ID Card to use. Moreover, one or more of the above-described steps of the alternative process may be omitted. In some examples, front-end software application need not display a notification that the virtual ID card was verified.

In some examples, method 700 allows for several advantages over other approaches. In some examples, method 700 allows the relying party with electronic device 103, equipped to read machine-readable code and the ability to conduct near field electronic communication (e.g. Bluetooth, NFC, and/or the like), or other electronic network access, to authenticate the virtual ID card presented by the user on the user's electronic device 102. With the human-readable or machine-readable displays, including display of for example, a URL and one-time use code, QR code, bar code, or unique set of image, or a unique set of audible tones, the previously recited process will also allow for a relying party to verify the virtual ID card without the need to communicate with a trusted intermediary, for example the backend system 101.

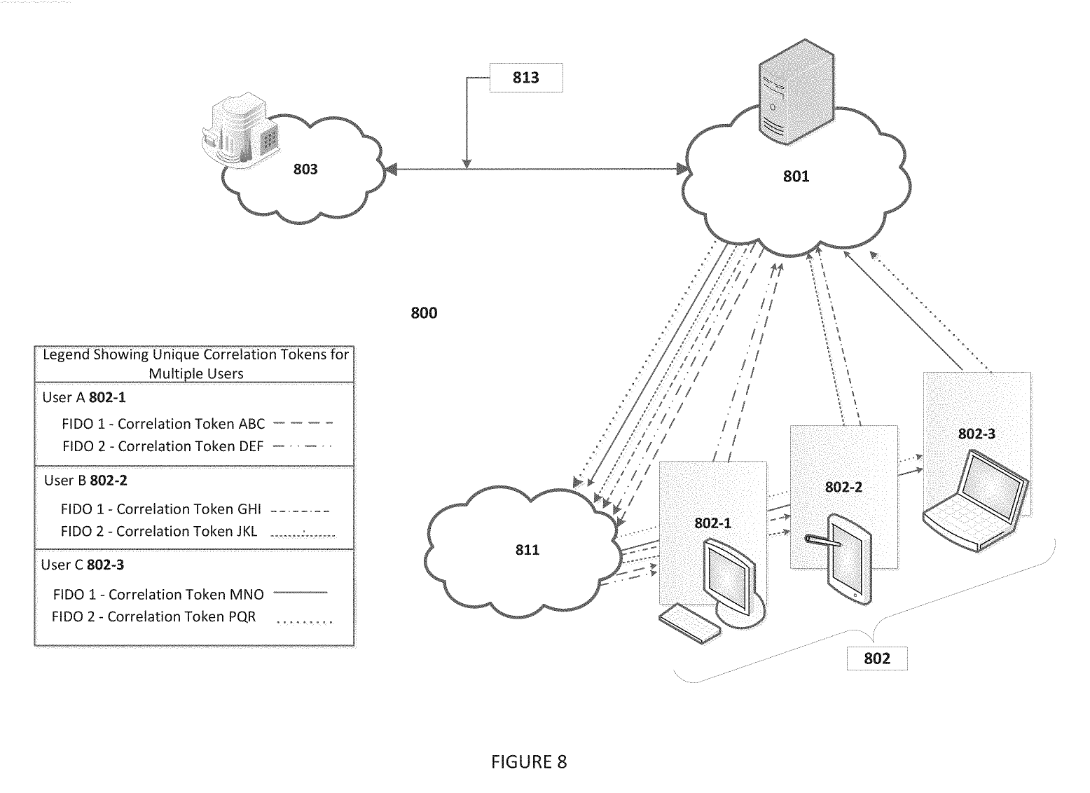

FIG. 8 is a diagram of a system 800 for virtual identity credential issuance or verification by a relying party among multiple users among other embodiments. The system 800 shown in FIG. 8 may reference one, some, or all of the systems and processes included in FIGS. 1-7, among other embodiments. As shown in FIG. 8, a relying party 803 may interface with a backend system 801 through the use of a dedicated, cryptographic protocol to establish a secure and authenticated communication path 813. In some examples, the relying party 803 is consistent with the relying party's electronic device 103 and the backend system 801 is consistent with the backend system 101. In some examples the secure and authenticated communication path 813 would be established through use of an SSL or TLS session. According to some embodiments, the relying party 803 may use the systems and methods described herein, even though their Internet browser software (for example Chrome, Safari, Internet Explorer®, and/or the like) may not be designed/configured to use FIDO or W3C authentication protocols; this ability may be described as FIDO-As-A-Service (FAAS). According to some embodiments FAAS systems and methods are described in the following paragraphs.

As part of establishing or registering for the FAAS, the relying party 803 may exchange PKI certificates with the backend system 801.

The relying party 803 may establish a communication path 813. In some examples the communication path 813 could be a mutually-authenticated TLS session with backend system 801.

According to some embodiments, the relying party 803 may establish the communication path 813 using a known federated authentication standard to connect to backend system 801. In some examples, known federated authentication standards could include Security Assertions Markup Language (SAML), Open authorization (OAuth) and OAuth 2.0, or OpenID Connect, and/or the like.

According to some embodiments, the relying party 803 may use the communication path 813 to conduct one or more identity verification sessions with one or more users via the backend system 801. In some examples, these identity verification sessions may be described as FAAS sessions.

According to some embodiments, a FAAS session may be established by the relying party 803 front-end software application making a data call to the backend system 801 through use of, in some examples, a proprietary application programming interface (API).

According to some embodiments, the FAAS session may be established with the backend system 801 to perform FIDO or W3C authentication actions or FIDO or W3C commands with one or more first users 802, for example a User A 802-1, User B 802-2, and User C 802-3, using a respective electronic device.

According to some embodiments, with the FAAS session established using communication path 813, the relying party 803 may perform one or more FIDO or W3C commands or transactions with the backend system 801 through the use of unique correlation tokens to identify one or more of User A 802-1, User B 802-2, and/or User C 802-3, and/or identify each FIDO or W3C command or transaction. In some examples, the communication path 813 may be long-lived such that communication path 813 may be used to execute FIDO or W3C commands associated with multiple users. In some examples, FIDO or W3C commands could include, but are not limited to credential generation, credential assertion, credential authentication or verification, and/or the like.

According to some embodiments, to perform a FIDO or W3C commands with User A 802-1, User B 802-2, and/or User C 802-3, upon receipt of a command from the relying party 803 in the FAAS session, the backend system 801 may establish a unique correlation token for that command.

In some examples, the backend system 801 may interrogate a database of backend system 801 to locate the virtual ID card information related to the specific user 802. In some examples the relying party may attempt to interface with any one of User A 802-1, User B 802-2, and/or User C 802-3, and /or others, and the backend system 801 may then communicate the unique correlation token along with the FIDO or W3C command from the relying party 803 to that specific user 802.

In some examples, the user 802 front-end software application 811 that may be installed on the user's electronic device may execute the FIDO or W3C command relayed by the backend system 801 from the relying party 803.

In some examples, the user 802 front-end software application 811 may transmit the result of its operation that executed the FIDO or W3C command to the backend system 801 along with the unique correlation token.

In some examples, the backend system 801 may transmit or forward the results of the user's execution of the FIDO or W3C command or action to the relying party 803 along with the unique correlation token.

The transmission of the results of the user's execution could conclude the FAAS session between the relying party 803 and backend system 801, or for multiple commands, in some examples related to User A 802-1, User B 802-2, and User C 802-3, and/or the like could be executed within that FAAS session and multiple unique correlation tokens may be generated.

According to some embodiments, the FAAS session could be established to execute the same FIDO or W3C command between the relying party 803 and multiple users, in some examples related to User A 802-1, User B 802-2, and User C 802-3, using a single unique correlation token generated for one specific command within the FAAS session.

As discussed above and further emphasized here, FIG. 8 is merely an example which should not unduly limit the scope of the claims. One of ordinary skill in the art would recognize many variations, alternatives, and modifications. In some embodiments, the relying party's 803 front-end software application may create the unique correlation token to execute the specific FIDO or W3C command before the FAAS session is established. In some examples, the user's 802 front-end software 811 may transmit the result of its operation that executed the FIDO command directly to the relying party 803 through an electronic means, such as radio communication using Bluetooth or NFC.

According to some embodiments, the relying party 803 may interface with the backend system 801 through the use of a dedicated, long-lived, cryptographic protocol to establish a secure and authenticated communication path 813 through the use of an authentication request to a third-party using a known standard such as OAuth, OAuth 2.0, OpenID Connect, and/or the like. In some examples, this may be advantageous to enable the relying party to use the systems and methods described herein, even though their Internet browser software (for example Chrome, Safari, Internet Explorer®, and/or the like) may not be designed to use FIDO or W3C authentication protocols.

In some examples, the backend system 801 may be consistent with backend system 101, 201, 301, and/or 501, and the relying party 803 may be consistent with relying party's electronic device 103. In some examples, User A 802-1, User B 802-2, or User C 802-3 may be consistent with user's electronic device 102, user's electronic device 202-3, user's electronic device 302-3, and/or user's electronic device 502-1.

Some examples of backend systems, electronic devices and/or the like, such as the devices of FIGS. 1-5 and/or 8 may include non-transitory, tangible, machine readable media that include executable code that when run by one or more processors may cause the one or more processors to perform the processes of methods 600 and/or 700. Some common forms of machine readable media that may include the processes of methods 600 and/or 700 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described herein as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

We claim:

1. A method of authenticating an identity of a user and facilitating a transaction between the user and a relying party, the method comprising:
establishing, by a backend system having a memory and a processor coupled to the memory, a communication path with a first electronic device of the user;
receiving, by the backend system, an identity credential data points of the user from an identity credential issuer;
receiving, by the backend system, an identity credential issued by the identity credential issuer from the user;
authenticating, by the backend system, the identity credential received from the user with the identity credential data points of the user from the identity credential issuer;
storing, by the backend system, the authenticated identity credential of the user as a virtual identity credential in the memory;
establishing, by the backend system, a communication path with a second electronic device of the relying party; and
facilitating transmission of identity credential information or identity credential verification commands between the user and the relying party.

2. The method according to claim 1, further comprising:
registering the identity credential issuer;
receiving, from the user, a presentation of a PKI-based identity credential previously issued to the user by the identity credential issuer;
validating the PKI-based identity credential presented by the user;
receiving, from the first electronic device of the user, a private key;
authenticating the PKI-based identity credential using the private key; and
storing the authenticated PKI-based identity credential of the user as the virtual identity credential in the memory.

3. The method according to claim 1, further comprising:
registering a government authority;
receiving, from the user, a presentation of a government-issued identity credential previously issued to the user by the government authority;
validating the government-issued identity credential presented by the user based on information provided by the government authority; and
storing the validated government-issued identity credential of the user as the virtual identity credential in the memory.

4. The method according to claim 1, further comprising:
establishing a secure communication path with a first communication node; and
transmitting a unique correlation token to the first communication node from transmission to an origin node.

5. The method according to claim 4, further comprising:
receiving data points of a user specified by the identity credential issuer;
transmitting a unique correlation token to the identity credential issuer for display to the user;
establishing a secure communication path to the first electronic device of the user;
transmitting a command to create a credential and a private key to the first electronic device of the user;
receiving a public key from the first electronic device of the user; and
transmitting the user specific data points to the first electronic device of the user.

6. The method according to claim 1, further comprising:
receiving, from the first electronic device of the user, a notification to initiate verification of a virtual identity credential selected by the user;
generating a one-time use code;
transmitting the one-time use code to the first electronic device of the user for display;
receiving, from the second electronic device of the relying party, the one-time use code received by the second electronic device of the relying party from its display on the first electronic device of the user;
parsing the one-time use code transmitted by the second electronic device of the relying party;
generating a unique one-time use verification code;
transmitting the one-time use verification code to the second electronic device of the relying party for display on the second electronic device of the relying party; and
transmitting a notification and the one-time use verification code to the first electronic device of the user for verification against the one-time use verification code displayed on the second electronic device of the relying party.

7. A system comprising:
a memory; and
a processor coupled to the memory, the processor being configured to:
establish a communication path with a first electronic device of a user;
receive an identity credential data points of the user from an identity credential issuer;
receive an identity credential issued by the identity credential issuer from the user;
authenticate the identity credential received from the user with the identity credential data points of the user from the identity credential issuer;
store the authenticated identity credential of the user as a virtual identity credential in the memory;
establish a communication path with a second electronic device of the relying party; and
facilitate transmission of identity credential information or identity credential verification commands between the user and the relying party.

8. The system according to claim 7, further comprising:
register the identity credential issuer;
receive, from the user, a presentation of a PKI-based identity credential previously issued to the user by the identity credential issuer;
validate the PKI-based identity credential presented by the user;
receive, from the first electronic device of the user, a private key;
authenticate the PKI-based identity credential using the private key; and
storie the authenticated PKI-based identity credential of the user as the virtual identity credential in the memory.

9. The system according to claim 7, further comprising:
register a government authority;
receive, from the user, a presentation of a government-issued identity credential previously issued to the user by the government authority;
validate the government-issued identity credential presented by the user based on information provided by the government authority; and
store the validated government-issued identity credential of the user as the virtual identity credential in the memory.

10. The system according to claim 7, further comprising:
establish a secure communication path with a first communication node; and
transmit a unique correlation token to the first communication node from transmission to an origin node.

11. The system according to claim 10, further comprising:
receive data points of a user specified by the identity credential issuer;
transmit a unique correlation token to the identity credential issuer for display to the user;
establish a secure communication path to the first electronic device of the user;
transmit a command to create a credential and a private key to the first electronic device of the user;
receive a public key from the first electronic device of the user; and
transmit the user specific data points to the first electronic device of the user.

12. The system according to claim 7, further comprising:
receive, from the first electronic device of the user, a notification to initiate verification of a virtual identity credential selected by the user;
generate a one-time use code;
transmit the one-time use code to the first electronic device of the user for display;
receive, from the second electronic device of the relying party, the one-time use code received by the second electronic device of the relying party from its display on the first electronic device of the user;
parse the one-time use code transmitted by the second electronic device of the relying party;
generate a unique one-time use verification code;
transmit the one-time use verification code to the second electronic device of the relying party for display on the second electronic device of the relying party; and
transmit a notification and the one-time use verification code to the first electronic device of the user for verification against the one-time use verification code displayed on the second electronic device of the relying party.

13. A non-transitory machine-readable medium comprising a plurality of machine-readable instructions which when executed by one or more processors associated with a backend system are adapted to cause the one or more processors to perform a method comprising:
establishing a communication path with a first electronic device of a user;
receiving an identity credential data points of the user from an identity credential issuer;
receiving an identity credential issued by the identity credential issuer from the user;
authenticating the identity credential received from the user with the identity credential data points of the user from the identity credential issuer;
storing the authenticated identity credential of the user as a virtual identity credential in a non-transitory machine-readable medium;
establishing a communication path with a second electronic device of the relying party; and
facilitating transmission of identity credential information or identity credential verification commands between the user and the relying party.

14. The non-transitory machine-readable medium according to claim 13, wherein the method further comprises:
registering the identity credential issuer;
receiving, from the user, a presentation of a PKI-based identity credential previously issued to the user by the identity credential issuer;
validating the PKI-based identity credential presented by the user;
receiving, from the first electronic device of the user, a private key;
authenticating the PKI-based identity credential using the private key; and
storing the authenticated PKI-based identity credential of the user as the virtual identity credential in the memory.

15. The non-transitory machine-readable medium according to claim 13, wherein the method further comprises:
registering a government authority;
receiving, from the user, a presentation of a government-issued identity credential previously issued to the user by the government authority;
validating the government-issued identity credential presented by the user based on information provided by the government authority; and
storing the validated government-issued identity credential of the user as the virtual identity credential in the memory.

16. The non-transitory machine-readable medium according to claim 13, wherein the method further comprises:
establishing a secure communication path with a first communication node; and
transmitting a unique correlation token to the first communication node from transmission to an origin node.

17. The non-transitory machine-readable medium according to claim 16, wherein the method further comprises:
receiving data points of a user specified by the identity credential issuer;
transmitting a unique correlation token to the identity credential issuer for display to the user;
establishing a secure communication path to the first electronic device of the user;
transmitting a command to create a credential and a private key to the first electronic device of the user;
receiving a public key from the first electronic device of the user; and
transmitting the user specific data points to the first electronic device of the user.

18. The non-transitory machine-readable medium according to claim 13, wherein the method further comprises:
receiving, from the first electronic device of the user, a notification to initiate verification of a virtual identity credential selected by the user;
generating a one-time use code;
transmitting the one-time use code to the first electronic device of the user for display;
receiving, from the second electronic device of the relying party, the one-time use code received by the second electronic device of the relying party from its display on the first electronic device of the user;
parsing the one-time use code transmitted by the second electronic device of the relying party;
generating a unique one-time use verification code;
transmitting the one-time use verification code to the second electronic device of the relying party for display on the second electronic device of the relying party; and
transmitting a notification and the one-time use verification code to the first electronic device of the user for verification against the one-time use verification code displayed on the second electronic device of the relying party.
